(19) United States
(12) Patent Application Publication
(10) Pub. No.: US 2021/0350290 A1
(43) Pub. Date: Nov. 11, 2021

(54) SYSTEM AND METHOD FOR EVENT ADMISSION

(71) Applicant: Benoit FREDETTE, Monaco (MC)

(72) Inventor: Benoit FREDETTE, Monaco (MC)

(21) Appl. No.: 17/282,875

(22) PCT Filed: Oct. 3, 2019
(86) PCT No.: PCT/CA2019/051418

§ 371 Date: Apr. 5, 2021

Related U.S. Application Data
(60) Provisional application No. 62/741,713, filed on Oct. 5, 2018.

(51) Int. Cl. G06Q 10/02; G06Q 30/08

(52) U.S. Cl. CPC G06Q 10/02; G06Q 30/08

(57) ABSTRACT

Systems and methods for managing access rights to an event are provided. During a bidding procedure, real-time bidding data comprising one or more bids for acquiring access to the event based on user-specific criteria is received. Historical, current, and future data related to at least one of the event, the venue, and a content provider are obtained. Real-time insights are output based on the bidding data and on the historical, current, and future data. This comprises returning a price to be paid to acquire at least one access right meeting the user-specific criteria and indicating at least one access right that can be acquired immediately in accordance with the one or more bids for optionally bypassing the bidding procedure. User input is received responsive to the insights and, responsive to the user input, access rights are automatically allocated to the event or access to an access rights selection platform is granted.

### CROSS REFERENCE TO RELATED APPLICATIONS

This patent application claims priority of U.S. provisional Application Ser. No. 62/741,713, filed on Oct. 5, 2018, the entire contents of which are hereby incorporated by reference.

### TECHNICAL FIELD

The present disclosure relates to the field of event admission, and more particularly to managing electronic access rights to events.

### BACKGROUND OF THE ART

Event attendees are typically required to purchase a ticket in order to enter the venue at which the event is held. The tickets can be obtained in different manners and it is usually desirable for attendees to purchase their tickets well in advance, especially for highly popular events. However, when purchasing the tickets, users typically have to pay a fixed price and may have a limited choice in terms of the seats that are available at the time their ticket is purchased. This may lead to reduced patron satisfaction.

There is therefore a need for an improved system and method for event admission and for managing electronic access rights to events.

### SUMMARY

In accordance with one aspect, there is provided a computer-implemented method for managing access rights to an event, the method comprising, at a computing device receiving, during a bidding procedure, real-time bidding data comprising one or more bids for acquiring access to the event based on user-specific criteria, obtaining historical data, current data, and future data related to at least one of the event, a venue, and a content provider, using at least one intelligent processing technique for outputting real-time insights based on the bidding data and on the historical data, the current data, and the future data, comprising at least one of returning, in real-time, a price to be paid to acquire at least one first access right meeting the user-specific criteria and to optionally bypass the bidding procedure and indicating, in real-time, at least one second access right that can be acquired immediately, in accordance with the one or more bids as received, to optionally bypass the bidding procedure, receiving user input responsive to the insights, and responsive to the user input, one of automatically allocating access rights to the event and granting access to an access rights selection platform.

In some embodiments, returning the price to be paid to acquire the at least one first access right meeting the user-specific criteria comprises using the at least one intelligent processing technique to determine, based on a point in time at which the one or more bids were placed and on at least one of the historical data, the current data, and the future data, a balance point in supply and demand for the at least one first access right, and determining the price based on the balance point and the bidding data.

In some embodiments, the historical data, the current data, and the future data vary in real-time, and generating the real-time insights based on the historical data, the current data, and the future data comprises using the at least one intelligent processing technique to adjust a weight allocated to each of the historical data, the current data, and the future data in real-time.

In some embodiments, the user-specific criteria comprises at least one of an event selection, at least one seat category, at least one seat section, and a number of seats to be purchased for the event.

In some embodiments, the historical data is obtained prior to a start of the bidding procedure and comprises at least one of demographic and socioeconomic factors related to the event and attendee market, demographic and socioeconomic factors related to a fan base of the content provider, historical performance metrics of the content provider, social media presence and performance of the content provider, data related to previous events from same or comparable content providers, previous data from same or comparable events, previous data from other events at the venue or similar venues, previous data from a specific location in the venue, and event data tagging.

In some embodiments, the current data is obtained during the bidding procedure and comprises any real-time change to the historical data, and the future data is obtained one or during the bidding procedure and after the bidding procedure ends and comprises any real-time change to the historical data and to the current data.

In some embodiments, the current data further comprises data related to the one or more bids actually placed during the bidding procedure and data related to one or more bids expected to be placed during the bidding procedure.

In some embodiments, obtaining the future data further comprises forecasting one or more pattern and statistical data points for the historical data and the current data.

In some embodiments, outputting the real-time insights comprises providing at least one of qualitative feedback and quantitative feedback on the one or more bids in real-time.

In some embodiments, receiving the user input responsive to the insights comprises receiving one of a modification to the one or more bids, an indication of acceptance to pay the price to acquire the at least one first access right meeting the user-specific criteria, an indication of acceptance to acquire the at least one second access right immediately, and an indication of acceptance to wait until an end of the bidding procedure to acquire access rights.

In some embodiments, the method further comprises, prior to receiving the bidding data, collecting the historical data, the current data, and the future data for at least one of each of a plurality of events, each of a plurality of venues, each of a plurality of content providers, and each of a plurality of users, and using the at least one intelligent processing technique to calibrate and correlate the historical data, the current data, and the future data across at least one of the plurality of events, venues, and content providers for generating, for any given one of the plurality of users, real-time recommendations as to at least one of an event, a venue, a content provider, a seat category, a seat section, a bid amount deemed appropriate for the user.

In accordance with another aspect, there is provided a system for managing access rights to an event, the system comprising a processing unit, and a non-transitory memory communicatively coupled to the processing unit and comprising computer-readable program instructions executable by the processing unit for receiving, during a bidding procedure, real-time bidding data comprising one or more bids for acquiring access to the event based on user-specific criteria, obtaining historical data, current data, and future data related to at least one of the event, a venue, and a content provider, using at least one intelligent processing technique for outputting real-time insights based on the bidding data and on the historical data, the current data, and the future data, comprising at least one of returning, in real-time, a price to be paid to acquire at least one first access right meeting the user-specific criteria and to optionally bypass the bidding procedure, and indicating, in real-time, at least one access right that can be acquired immediately, in accordance with the one or more bids as received, to optionally bypass the bidding procedure, receiving user input responsive to the insights, and responsive to the user input, one of automatically allocating access rights to the event and granting access to an access rights selection platform.

In some embodiments, the instructions are executable by the processing unit for returning the price to be paid to acquire the at least one first access right meeting the user-specific criteria, comprising using the at least one intelligent processing technique to determine, based on a point in time at which the one or more bids were placed and on at least one of the historical data, the current data, and the future data, a balance point in supply and demand for the at least one first access right, and determining the price based on the balance point and the bidding data.

In some embodiments, the instructions are executable by the processing unit for generating the real-time insights based on the historical data, the current data, and the future data comprising using the at least one intelligent processing technique to adjust a weight allocated to each of the historical data, the current data, and the future data in real-time, the historical data, the current data, and the future data varying in real-time.

In some embodiments, the instructions are executable by the processing unit for obtaining the historical data prior to a start of the bidding procedure, obtaining the current data during the bidding procedure, and obtaining the future data one or during the bidding procedure and after the bidding procedure, the current data comprising any real-time change to the historical data, and the future data comprising any real-time change to the historical data and to the current data.

In some embodiments, the instructions are executable by the processing unit for obtaining the current data further comprising data related to the one or more bids actually placed during the bidding procedure and data related to one or more bids expected to be placed during the bidding procedure.

In some embodiments, the instructions are executable by the processing unit for obtaining the future data comprising forecasting one or more pattern and statistical data points for the historical data and the current data.

In some embodiments, the instructions are executable by the processing unit for outputting the real-time insights comprising providing at least one of qualitative feedback and quantitative feedback on the one or more bids in real-time.

In some embodiments, the instructions are executable by the processing unit for receiving the user input responsive to the insights comprising receiving one of a modification to the one or more bids, an indication of acceptance to pay the price to acquire the at least one first access right meeting the user-specific criteria, an indication of acceptance to acquire the at least one second access right immediately, and an indication of acceptance to wait until an end of the bidding procedure to acquire access rights.

In some embodiments, the instructions are further executable by the processing unit for, prior to receiving the bidding data collecting the historical data, the current data, and the future data for at least one of each of a plurality of events, each of a plurality of venues, each of a plurality of content providers, and each of a plurality of users, and using the at least one intelligent processing technique to calibrate and correlate the historical data, the current data, and the future data across at least one of the plurality of events, venues, and content providers for generating, for any given one of the plurality of users, real-time recommendations as to at least one of an event, a venue, a content provider, a seat category, a seat section, a bid amount deemed appropriate for the user.

### BRIEF DESCRIPTION OF THE DRAWINGS

Further features and advantages of the present invention will become apparent from the following detailed description, taken in combination with the appended drawings, in which:

FIG. 1 is a flowchart of a method for event admission, in accordance with an illustrative embodiment of the present invention;

FIG. 2 is a flowchart of the step of FIG. 1 of using machine learning/artificial intelligence (AI) techniques to generate insights in real-time;

FIG. 3 is a flowchart of the step of FIG. 2 of returning a price to be paid to secure access right(s) meeting user-specific criteria;

FIG. 4 is a flowchart of a method for event admission, in accordance with another illustrative embodiment of the present invention;

FIG. 5 is a flowchart of the step of FIG. 4 of generating recommendations;

FIG. 6 is a schematic diagram of a system for event admission, in accordance with an illustrative embodiment of the present invention; and

FIG. 7 is a schematic diagram of an application running on the processor of FIG. 6.

It will be noted that throughout the appended drawings, like features are identified by like reference numerals.

### DETAILED DESCRIPTION

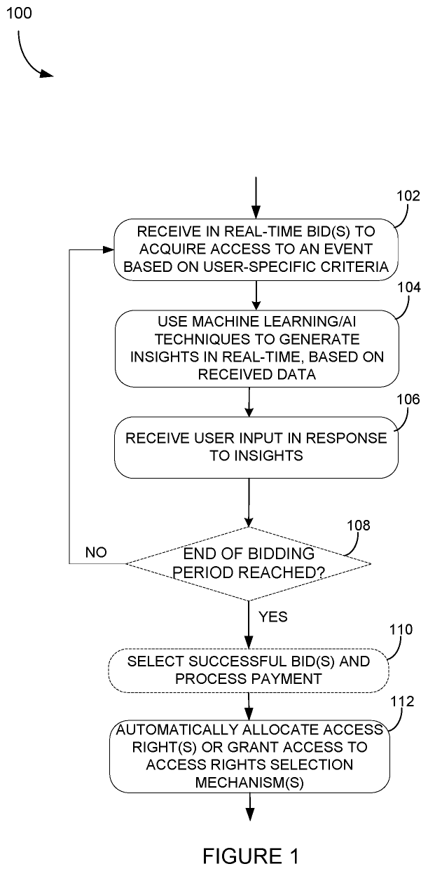

Referring to FIG. 1, a computer-implemented method 100 for event admission, in accordance with one embodiment, will now be described. The method 100 allows users to obtain, through a computer-based access rights managing platform associated with a venue, an event, or a content provider, access rights for upcoming events that are to occur at the venue. The event may be a live entertainment event, such as a live concert, a sports game, or the like, and may be provided by a content provider, such as an artist, sports team or the like. The venue may be a facility, such as a stadium/arena, a theater, a concert hall, or the like, where physical spaces, such as seats, are uniquely assigned to attendees. It should be understood that, for seat-less venues or events (e.g. outdoor festival shows) or the like where general admission or open seating is used, the physical spaces assigned to attendees may comprise sections of the venue (e.g. balcony or floor) rather than specific seats. Therefore, the expression “seat” is used herein to refer to a physical space or defined area at a venue.

It should also be understood that, although the description below refers to an entertainment venue (e.g. a stadium/arena), other venues, such as convention centers may apply. Access to the venue is illustratively controlled by means of any type of access right, such as any suitable proof of purchase, which may be electronic or physical, and indicates that one has paid for admission to an event occurring at the venue and which may further be used to assign a specific seat to a holder of the access right. As used herein, the term “access right” therefore refers to a right that is acquired by a user to have access to an event or venue.

The attendee is typically expected to remain at his/her assigned seat during most of the event. As discussed above, in some venues, no seats will be assigned to attendees and the seat location indicia provided on the access right then indicates a section of the venue, rather than the specific physical location of a seat. In one embodiment, the access right includes seat location indicia (e.g. row number and seat number) uniquely defining the physical location of the attendee's seat at the venue. In another embodiment, the user is provided with a proof of purchase associated with a unique profile of the user, as will be discussed further below. Admission to the venue can be controlled by verifying the user's profile information to confirm that the user has indeed acquired rights to one or more seats at the venue and thereby be admitted to the event.

The method 100 illustratively comprises, at step 102, receiving in real-time, during a computer-implemented bidding procedure, one or more bids from user(s). Each user indeed places one or more bids (through the access rights management platform) to acquire access to an event, based on user-specific criteria. In one embodiment, the user-specific criteria is entered by the user and comprises a selection of an event the user wishes to attend. In some embodiments, the user-specific criteria comprises additional criteria including, but not limited to, at least one seat category, at least one seat section, and a number of seats to be purchased. In embodiments where best available seats are allocated to users, the user-specific criteria may comprise an indication that all access rights available at the venue are of interest to the user. The user may then indicate the price they are willing to pay (i.e. their bid) to acquire access right(s), e.g. purchase seat(s), for the event in accordance with the criteria they entered. A plurality of bidding mechanisms, including but not limited to Vickrey auction and Dutch auction, may apply.

At the end of the method 100, users are either automatically allocated access right(s) or granted access to one or more access rights selection mechanisms (or platforms), as described in co-pending U.S. application Ser. No. 15/575,770 entitled SYSTEM AND METHOD FOR MANAGING EVENT ACCESS RIGHTS, and which the entire disclosure thereof is hereby incorporated by reference. Indeed, in some embodiments, users are automatically allocated access right(s) (e.g. seat(s)). In other embodiments, users may be asked to pay a fee, separate from, part of, or associated with the bid amount, in order to make an access rights selection instead of being automatically allocated access right(s). In this case, the one or more access rights selection mechanisms may comprise a prioritized access rights selection mechanism in which users are granted the right to acquire their access right(s) in priority (e.g. before other users). In another embodiment, the one or more access rights selection mechanisms may comprise a mechanism in which all users are granted the same opportunity to acquire their access right(s) and all users have an equal chance to select their access right(s) (i.e. without prioritized access rights selection being available).

The bids are illustratively placed once an event is announced and the bidding room is opened. In some embodiments, bids are received without any monetary value having been assigned to any of the seats for the event. For example, a concert for a given artist is announced for a specific date and the bidding is opened for a predetermined time period without setting any upper and/or lower monetary value limits for the bids. Alternatively, upper and/or lower monetary value limits may be set for a given event. For example, a minimum bid amount may be required in order to participate in the bidding procedure.

It should be understood that, in some embodiments, only registered users may be allowed to place bids at step 102. In other embodiments, all users, registered or not, are allowed to place bids. As such, step 102 may also comprise assessing whether the user(s) having placed the bid(s) are registered users. This may be performed by comparing, for each bidding user, an identifier (e.g. username and/or password) received from the user upon receipt of his/her bid to an identifier retrieved from memory. If both identifiers match, the bidding user is successfully authenticated and it is determined that the user is a registered user.

Step 102 may also comprise collecting payment data for each received bid. This may be achieved using payment information provided by the bidding user(s) at step 102, along with their bids. It should be understood that the payment data may also be retrieved from memory (e.g. obtained from the user's profile information, discussed further below). In some embodiments, pre-authorization of payment is obtained with the payment data. Alternatively, payment data is collected for later use without the need for a pre-authorization. This embodiment may be favored in instances where the bidding process is long and it may not be practical to hold large amounts on users' credit cards. In other embodiments, payment data is only collected later in the process, for example once the bid has been deemed successful.

The payment data may comprise a payment amount and in some cases a method of payment. The data related to the method of payment may comprise credit card information, financial account information, account debit authorization information, electronic funds transfer information, or the like. The payment data may also comprise a stored payment value that is associated with the user's profile and that indicates that funds are associated with the user's profile. It should be understood that payment will only be processed (e.g. by charging a credit card, financial account, or the like, of the user) for successful bids.

Still referring to FIG. 1, after bids have been received at step 102, the next step 104 is to use machine learning (ML) and/or artificial intelligence (AI) technique(s) to generate insights in real-time, based on the data received at step 102. User input may then optionally be received at step 106, in response to the insights generated and provided to the user at step 104, as will be discussed further below. As used herein, machine learning and/or AI techniques refers to any suitable computer-based algorithm that can learn from data and make data-driven predictions or decisions, by building a model from sample inputs. In particular, the ML and/or AI techniques referred to herein may be intelligent processing techniques that weight various factors to give the systems and methods described herein the ability to learn (e.g. improve performance, progressively and over time, on tasks described herein in connection with the bidding procedure). ML and/or AI techniques referred to herein include, but not limited to, decision tree learning, association rule learning, support vector machines, cluster analysis (unsupervised learning), and reinforcement learning. It should however be understood that other suitable techniques may apply.

Optionally, the next step 108 may then be to determine whether the bidding period has ended. In some embodiments, bids may indeed only be received for a predetermined period of time and the bidding period may end at a pre-determined date and/or time (e.g. forty-eight (48) hours after the on-sale date/time). If it is determined at step 108 that the end of the bidding period has not been reached, the method 100 optionally flows back to the step 102 of receiving bid(s) in real-time. If it is determined at step 108 that the end of the bidding period has been reached, the bidding is closed and the received bid(s) are evaluated to optionally select successful bid(s) and process payment (step 110). Successful bidder(s) are illustratively identified and notified, e.g. by outputting a corresponding message for transmission to each of the successful bidder(s). In one embodiment, bids are evaluated at step 110 by associating a rank or standing with each bid received at step 102, thereby providing an ordering of received bids. Whenever a higher standing bid is received, lower standing bid(s) are removed from the order (or “bumped”), unless additional access rights (e.g. seats) are available for selection. In some embodiments, when equal bids are made, the one of the equal bids that was placed at an earlier time may have precedence. Other factors may also be used to select from equal bids when the number of equal bids exceeds the number of available access rights. Next, at step 112, the user is then automatically allocated one or more access rights or granted access to one or more access rights selection mechanisms (according to the bid(s) received at step 102 and the user input received at step 106) and seat(s) are then allocated.

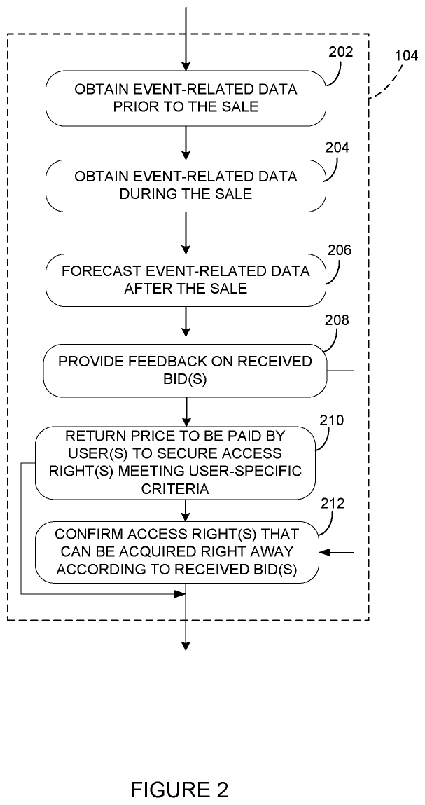

Referring now to FIG. 2, the step 104 of generating insights in real-time comprises obtaining data (referred to herein as “historical data”) prior to the sale or auction (i.e., prior to a start of the bidding procedure, step 202) and obtaining data (referred to herein as “current data”) during the sale (i.e., while the bidding procedure is undergoing, step 204) and forecasting the data of steps 202 and 204 (e.g., during the bidding procedure or after an end of the bidding procedure, step 206). The historical data, the current data, and the future data is related to the event, a venue, and/or a content provider. ML and/or AI techniques are then used to generate in real-time, based on the data obtained at steps 202, 204, and 206 and on the data received at steps 102 and 104 of FIG. 1, insights comprising providing feedback on received bid(s) at step 208, and returning a price to be paid by the user to secure access right(s) meeting user-specific criteria at step 210 and/or confirming access right(s) that can be acquired right away according to the received bid(s) at step 212. The user input received at step 106 of FIG. 1 may then comprise an indication from the user that they are willing to accept the price returned at step 210, an indication that the user is willing to accept the access right(s) recommended at step 212, a modification to the user's original bid received at step 102 of FIG. 1, or no modification to the original bid, indicating that the user is willing to wait until the end of the bidding period to acquire their access right. It should be understood that the bidding procedure is skipped or bypassed (i.e. the user does not have to wait for the bidding period to end) and the access rights are secured if the user input comprises an indication that the user is willing to accept the price returned at step 210 or an indication that the user is willing to accept the access right(s) recommended at step 212.

In one embodiment, real-time qualitative and/or quantitative feedback on the bid(s) placed by the user is provided at step 208. For example, the user may be provided with an indication of how his/her bid compares to other bid(s) (e.g. how good the bid is). Step 208 may also comprise indicating to the user that, should the user place a subsequent bid at a later time, he/she would have to place a higher (or lower) bid to secure the same desired access right(s). Other embodiments may apply.

In one embodiment, step 212 comprises determining, based on the bid(s) entered by the user(s) (as received at step 104 of FIG. 1), which access right(s) can be acquired by the user(s), in the entire venue, at the time the user(s) enters their bid(s). For example, if the user enters a bid of $100, step 212 determines and indicates to the user the access right(s) that can be secured right away by the user for $100. This is achieved using ML and/or AI techniques in one embodiment.

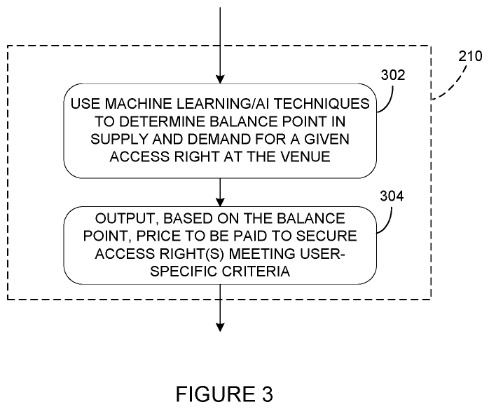

Referring now to FIG. 3 in addition to FIG. 2, step 210 comprises determining a price to be paid (e.g. a bid to be placed) by the user to secure access right(s) meeting the user-specific criteria. For example, the user may have placed (at step 102 of FIG. 1) a bid having a value of $70. It may however be determined at step 210 that the user would have to pay $300 to be able to secure access right(s) (e.g. seats) meeting the user-specific criteria. For this purpose, in one embodiment, step 210 comprises using ML and/or AI techniques at step 302 to determine a balance point (also referred to herein as a “point of equilibrium”) in supply and demand for a given access right (e.g. seat) at the venue, based on the data obtained at steps 202, 204, and 206 as well as on the point in time at which the user placed their bid (as will be described further below). The balance point may thus be determined based on computer-based models (e.g., built using the ML and/or AI techniques). In another embodiment, the balance point in supply and demand may be determined by computing an average, based on the collected data. The price to be paid by the user to secure the desired access right (e.g. the seat meeting the user-specific criteria) can then be determined, based on the balance point determined at step 302 and on the initial bid received from the user. The price to be paid is then output at step 304. If the user then accepts the price returned at step 304 and decides to acquire their access right(s) right away (as indicated in the user input received at step 106 of FIG. 1), the bidding procedure stops for this user. In this manner, the user does not have to wait for the bidding period to end prior to acquiring their access right(s) (e.g., securing seat(s)) for the event.

It should be understood, as discussed further below, that the weight (e.g., the importance) given to the collected data points is adjusted over time using the ML/AI techniques. For instance, although step 210 is described and illustrated herein as being preferably performed on the basis of the data points obtained at all three of steps 202, 204, and 206, it should be understood that the price to be paid may be determined at step 210 using the data points obtained at one or more of steps 202, 204, and 206.

In one embodiment, the data obtained prior to the sale at step 202 includes, but is not limited to, demographic and socioeconomic factors related to the event and attendee market, demographic and socioeconomic factors related to the fan base of the content provider, historical performance metrics (e.g. Billboard charts, league rankings, record sales, streaming stats, performance trajectories/patterns, and others) of the content provider, social media presence and performance of the content provider, data (e.g. sales, attendance, resale, offers or bids made, loyalty, and others) related to previous events from same or comparable content providers, previous data from same or comparable events, previous data from other activities or events at the same venue or similar venues, previous data from a specific location in a venue, and any possible event data tagging (e.g. performer, songs, attendance, scores, players, crowd reaction, and the like). The data may comprise readily available data (e.g. obtained from the content provider, the venue, or any other suitable source) stored in a memory or other suitable data storage means and may be retrievable therefrom using any suitable means.

The data obtained at step 204 may comprise any real-time change to the data collected at step 202. The data obtained at step 204 may further comprise data related to the offers (e.g. bids) made during the sale and data related to offers expected to be made during the sale. This may include, but is not limited to, the number of offers, seat quantity, price, requested seat categories, location of offerers (or bidders), Internet Protocol (IP) address, and other relevant data points of offerers. The data obtained at step 204 may also comprise pattern and statistical data point(s) of offers made and pattern and statistical data point(s) of offers expected during the sale. The pattern and statistical data points include, but are not limited to frequency, volatility, variance, and standard deviation.

The data obtained (or forecasted) at step 206 comprises any real-time changes to the data collected at steps 202 and 204, and to any other relevant data. The data may be obtained at step 206 during the bidding procedure or after the bidding procedure. The data obtained at step 206 may further comprise pattern and statistical data point(s) expected or forecasted (e.g., during or after the sale), for the data collected at step 202 (i.e. prior to the sale) and at step 204 (i.e. during the sale). For example, the data obtained at step 206 may comprise a frequency, volatility, variance, and/or standard deviation of historical performance metrics of the content provider. The data obtained at step 206 may further comprise pattern and statistical data point(s) of transactions expected after the sale.

At step 302, ML and/or AI techniques are used to calibrate the data points obtained at steps 202, 204, 206 in real-time for the purpose of determining a point of equilibrium between supply and demand. It should be understood that the point of equilibrium may be reached within a predetermined tolerance. It should also be understood that, because the data points obtained at step 202, 204, 206 vary continuously and in real-time, the data calibration performed at step 302 illustratively varies or evolves over time (e.g. the weight given to the collected data points is adjusted over time using the ML/AI techniques). In particular, in one embodiment, the data obtained at step 202 (i.e. prior to the sale) may initially be given more weight when performing the data calibration at step 302. For example, the historical performance metrics of the content provider may initially be used to determine the point of equilibrium. Over time, as more pattern data (e.g. data obtained during and/or after the sale) is obtained, the pattern data may become more relevant than the historical data (e.g. data obtained prior to the sale) and the calibration process performed at step 302 may give more weight to the data obtained at steps 204 and 206 to determine the price to be paid by the user to secure the access right(s) meeting the user-specific criteria.

For example, if historical performance metrics of the content provider indicate that sales were previously low but current performance metrics indicate that sales are picking up, the price to be paid may be increased. As another example, if current data indicates that an increasing number of users is placing bids but bids are being placed on selected access rights only, indicating a low interest for remaining access rights, the price to be paid for securing any of the remaining access rights may be lowered.

As another example, if the historical data indicates that demand for access rights for a given event historically tends to be initially high (e.g., when the bidding room is opened) but then tends to decrease over time, and the current data indicates that, for the current bidding procedure, only a few users have placed bids for access rights for the given event since an opening of the bidding room, the ML and/or AI techniques may determine possible causes for the current low demand. If it is determined that the current demand is low, not due to a lack of interest in the given event (e.g., a lack of popularity of the artist(S) associated with the event) but rather due to other reason(s) (e.g., time at which bidding was opened being inappropriate), the price to be paid for securing access rights for the event may be maintained (rather than lowered, as may be done with conventional techniques).

In one embodiment, forecasted data may provide an accurate indication of data patterns when the end of the bidding period is close to being reached while the forecasted data is more likely to vary over time when the bidding period is starting. As such, a higher price to be paid may be set at the beginning of the bidding period than at the end. Also, the data obtained after the sale may indicate the likelihood that the value of access rights for the event will increase (or decrease), thus having an impact on determination of the price to be paid. The calibration performed at step 302 may thus be adjusted accordingly, in real-time. It should be understood that the calibration performed at step 302 to determine the point of equilibrium is preferably computer-based (i.e. performed by a computer device in real-time).

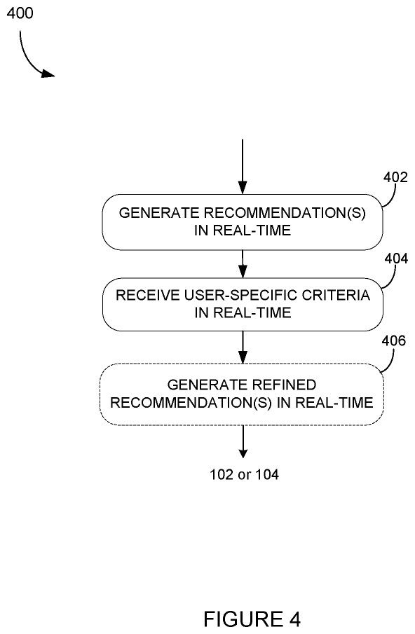

Referring now FIG. 4, a method 400 for event admission, in accordance with another embodiment, will now be described. The method 400 comprises generating in real-time one or more recommendation(s) at step 402, as will be discussed further below. As used herein, the term “recommendation” includes, but is not limited to, a recommendation of an event, venue, content provider, seat category, seat section, price (e.g. bid amount), that is deemed of interest to or suitable for (i.e., appropriate for) the user, based on information (e.g. geographical location, expressions of interest, bidding history, bidding profile, activity, etc.) unique to the user.

The recommendation(s) may then be output to the user who, in one embodiment, selects one (or more) of the recommendations and places one or more bids accordingly. In another embodiment, the user may choose not to select any of the returned recommendation(s). User-specific criteria, including at least an event selection and optionally including, but not limited to, one or more of a seat category, a section, and a seat number (as discussed herein above) is accordingly received in real-time at step 404. The recommendation(s) generated at step 404 may then be refined in real-time at step 406, based on the criteria received at step 404. The method 400 then flows to step 102 or step 104 of FIG. 1, where bid(s) are received in real-time. The subsequent steps of FIG. 1 are then performed. Both methods 400 and 100 may therefore be performed jointly.

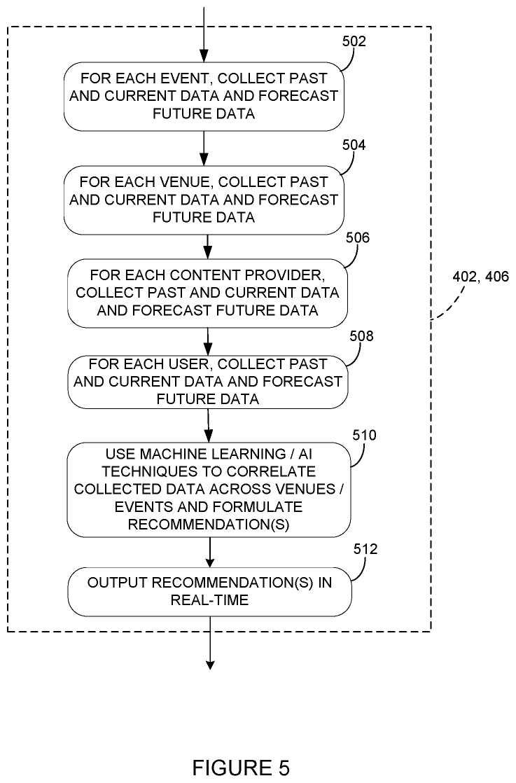

Referring to FIG. 5, the steps 402 and 406 of generating recommendations comprise returning recommendations to a user for a given event based on data related to different events and/or returning recommendations for a given venue based on data related to different venues. The recommendations may be used to help guide the user's decision making process and illustratively relate to offered price (e.g. bid value) and event location. An example of a recommendation is as follows: “If you like sitting next to first base at Yankee Stadium for $180, you will enjoy sitting on top of the Green Monster for $140 at Fenway Park”.

For this purpose, for each event that users can bid on, past data (e.g. data prior to the sale) and current data (e.g. data during the sale) is collected and future data (e.g. data expected after the sale) is forecasted at step 502. For example, the data collected at step 502 may comprise, for each event at the venue, an artist name, event date, event time, event location, information about anything notable having occurred on the day of the event, and any other relevant tagging information for the event. At step 504, past, current, and future data is obtained for each venue. The data collected at step 504 may comprise venue-related data including, but not limited to, view angles, elevation, and similarities between venue configuration or structure. Past, current, and future data is also obtained at step 506 for each content provider (e.g. each artist, sports team, or the like). In addition, past and current data is collected and future data is forecasted at step 508 for each bidding user. The user data collected at step 508 may be obtained from the user's profile or account and may provide an indication of the user's interests, bid history, bidding activity, geographical location, and the like.

ML and/or AI techniques are then used at step 510 to correlate the data collected at steps 502, 504, 506, and 508 across venues, content providers, and/or events and formulate one or more recommendation(s), which are then output in real-time at step 512. For this purpose, the ML and/or AI techniques are configured to calibrate the data points obtained at steps 502, 504, 506, and 508 in real-time. Because the data points obtained at step 502, 504, 506, and 508 vary continuously and in real-time, the data calibration illustratively varies over time (e.g. the weight given to the collected data points is adjusted over time using the ML/AI techniques). For instance, although step 510 is described and illustrated herein as being preferably performed on the basis of the data points obtained at all four of steps 502, 504, 506, and 508, it should be understood that the recommendation(s) may be formulated at step 510 using the data points obtained at one or more of steps 502, 504, 506, and 508. In this manner, it is possible to make recommendations across multiple events, across multiple content providers, and across multiple venues, the recommendations evolving in real-time.

Although reference is made herein to a bidding procedure, it should be understood that, in some embodiments, the performance of the intelligent processing technique(s) described herein may be such that the systems and methods described herein may allow to build (e.g., based on the collected historical, current, and future data) model(s) that are accurately representative of the attendee market. As a result, the systems and methods described herein may readily provide users with an indication of a price to be paid to acquire access right(s), alleviating the need for users to enter bids during a bidding procedure. Reference is therefore made herein to a “sale”, which refers to a procedure (including, but not limited to, a bidding procedure) during which access rights can be acquired by users in exchange for payment of a given monetary amount.

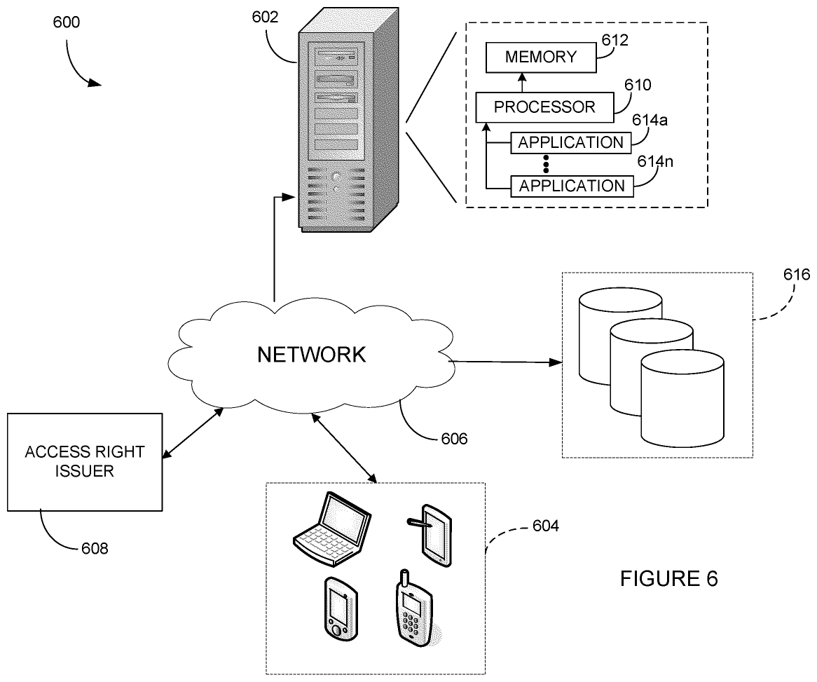

Referring now to FIG. 6, a system 600 for event admission, in accordance with one embodiment, will now be described. The system 600 may comprise one or more server(s) 602 adapted to communicate with a plurality of mobile devices 604 via a network 606, such as the Internet, a cellular network, Wi-Fi, or others known to those skilled in the art. As will be discussed further below, the devices 604 may provide users access to the system 600 for securing admission to events occurring at the venue. The devices 604 may comprise any device, such as a laptop computer, a personal digital assistant (PDA), a tablet, a smartphone, or the like, adapted to communicate over the network 606.

In one embodiment, the system 600 requires users to log in or otherwise gain authorized access to the system 600 through the use of a unique identifier. For this purpose, users illustratively register with the system 600 by completing an application, thereby creating a unique profile or account that may be stored in the memory 612 and/or databases 616. This may be done by accessing a website, mobile application, or other suitable access means associated with the system 600 using the user's device 604. Once registration is complete, each user is illustratively provided with a unique identifier that may be encrypted using any encryption method, such as an email address, a username, and/or a password, associated with his/her profile. The identifier may be used to verify the identity of the user upon the user attempting to access the system 600. For example, the unique identifier may be compared to a government database or another source of data used for identification purposes. In some embodiments, the unique identifier is a mobile phone number and is compared to a list of authorized and/or unauthorized mobile phone numbers, for security purposes. Other security measures may also be applied to verify the identity of the user. Access to the system 600 may then be effected by the user logging on to the website with the identifier, accessing a mobile application, using an authentication technique such as facial recognition, and/or using any other suitable access means. Alternatively, the system 600 may be installed on the device 604 as a software application, which may be launched by the user on the device 604. It should be understood that the system 600 may be accessed by multiple users simultaneously. It should also be understood that a given user may log into the system 600 using an identifier associated with an online social network or social networking application (e.g. Facebook™, Google+™, Twitter™ or the like) to which the user has subscribed.

In one embodiment, an electronic wallet containing payment information, digital coupons, a history of used access rights, active access rights for future events, and other relevant information, may be associated with each user profile. The electronic wallet may also comprise a photograph of the user that can be used, for instance, for facial recognition purposes during an ID validation step. The system 600 may also associate the user's profile with a unique encrypted token that is temporary and representative of a proof of purchase (e.g. of an access right purchased by the user). The token may contain information, such as the price value associated with the purchased access right as well as other relevant information (e.g. seat number, identification of the venue, identification of the event, etc.) identifying the venue and/or event. It should be understood that, since a given user may purchase multiple access rights, a given user profile may hold multiple tokens, e.g. having different price values.

The server 602 may further be accessed by an access right issuer 608. In one embodiment, the access right issuer 608 provides the server 602 with pricing information for the access rights, e.g. a minimum price value for each category of access right. The access right issuer may also provide other relevant information, including, but not limited to, a seating map or layout, seat sections, standing access right details, inventory data (e.g. information about access rights available at the venue), and the like.

The server 602 may comprise a series of servers corresponding to a web server, an application server, and a database server. These servers are all represented by server 602 in FIG. 6. The server 602 may comprise, amongst other things, a processor 610 coupled to a memory 612 and having a plurality of applications 614a, . . . , 614n running thereon. The processor 610 may access the memory 612 to retrieve data. The processor 610 may be any device that can perform operations on data. Examples are a central processing unit (CPU), a microprocessor, and a front-end processor. The applications 614a, . . . , 614n are coupled to the processor 610 and configured to perform various tasks as explained below in more detail. It should be understood that while the applications 614a, . . . , 614n presented herein are illustrated and described as separate entities, they may be combined or separated in a variety of ways. It should be understood that an operating system (not shown) may be used as an intermediary between the processor 610 and the applications 614a, . . . , 614n.

The memory 612 accessible by the processor 610 may receive and store data. The memory 612 may be a main memory, such as a high speed Random Access Memory (RAM), or an auxiliary storage unit, such as a hard disk or flash memory. The memory 612 may be any other type of memory, such as a Read-Only Memory (ROM), Erasable Programmable Read-Only Memory (EPROM), or optical storage media such as a videodisc and a compact disc. Also, although the system 600 is described herein as comprising the processor 610 having the applications 614a, . . . , 614n running thereon, it should be understood that cloud computing may also be used. As such, the memory 612 may comprise cloud storage.

One or more databases 616 may be integrated directly into the memory 612 or may be provided separately therefrom and remotely from the server 602 (as illustrated). In the case of a remote access to the databases 616, access may occur via any type of network 606, as indicated above. The databases 616 described herein may be provided as collections of data or information organized for rapid search and retrieval by a computer. The databases 616 may be structured to facilitate storage, retrieval, modification, and deletion of data in conjunction with various data-processing operations. The databases 616 may consist of a file or sets of files that can be broken down into records, each of which consists of one or more fields. Database information may be retrieved through queries using keywords and sorting commands, in order to rapidly search, rearrange, group, and select the field. The databases 616 may be any organization of data on a data storage medium, such as one or more servers. As discussed above, the system 600 may use cloud computing and it should therefore be understood that the databases 616 may comprise cloud storage.

In one embodiment, the databases 616 are secure web servers and Hypertext Transport Protocol Secure (HTTPS) capable of supporting Transport Layer Security (TLS), which is a protocol used for access to the data. Communications to and from the secure web servers may be secured using Secure Sockets Layer (SSL). Identity verification of a user may be performed using usernames and passwords for all users. Various levels of access authorizations may be provided to multiple levels of users.

Alternatively, any known communication protocols that enable devices within a computer network to exchange information may be used. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol).

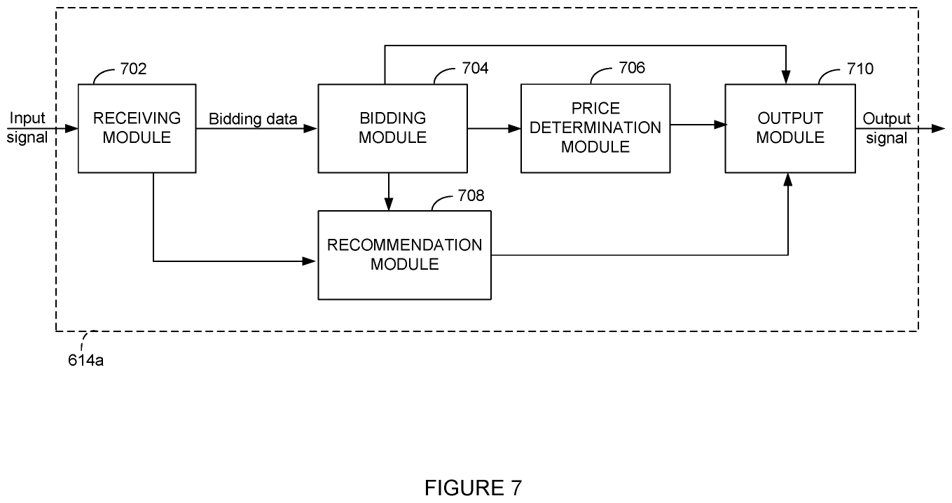

FIG. 7 is an exemplary embodiment of an application 614a running on the processor 610 of FIG. 6. The application 614a illustratively comprises a receiving module 702, a bidding module 704, a price determination module 706, a recommendation module 708, and an output module 710.

The receiving module 702 illustratively receives one or more input signals from one or more device(s) 604 and/or the access right issuer 608. The input signal(s) received from each device 604 may comprise input data uniquely identifying the user, e.g. the user's identifier associated with his/her account in the system 600. The user identifier may indeed be received upon the user attempting to gain access to the system 600 for securing admission for an event. The user identifier may then be sent by the receiving module 702 to the bidding module 704 for authenticating (e.g. through comparison of the user identifier with a stored user identifier) the user prior to providing the user access to functionalities of the system 600.

The input data received from a device 604 at the receiving module 702 may also comprise bidding data as well as user-specific criteria associated with the bid(s). The user-specific criteria may uniquely identify a seat category and/or a location of a seat or section of the venue for which the user wishes to obtain an access right. Payment data (e.g. credit card information, financial account numbers, account debit authorizations, electronic funds transfer information, and other relevant payment information) may also be received. The input data may then be sent by the receiving module 702 to the bidding module 704, the price determination module 706, and the recommendation module 708, which are configured to use ML and/or AI techniques to implement the method steps discussed above with reference to FIG. 1, FIG. 2, FIG. 3, FIG. 4, and FIG. 5. In particular, the bidding module 704 may be configured to confirm the access right(s) that can be acquired according to the received bid(s). The price determination module 706 may be used to determine a price to be paid to secure access right(s) meeting user-specific criteria. The recommendation module 708 may be used to generate recommendations (including but not limited to recommendations for a given event, content provider, venue, seat category, seat section, price, and the like), as discussed herein above.

The modules 704, 706, and 708 may then each output their outcome (e.g. recommendations, access right(s) that can be selected according to received bid(s), or price to be paid to secure right away access right(s) meeting user-specific criteria) to the output module 710 for presentation of the information to the users, e.g. rendering on a suitable output device provided with the user's device 604 or transmission to the device 604 through instant push notifications sent via the network 606. Email, Short Message Service (SMS), Multimedia Messaging Service (MMS), instant messaging (IM), or other suitable communication means.

In one embodiment, upon accessing the venue the day of the event, the user may present the access right (e.g. using the output device provided with their device 604) for scanning of a portion, e.g. a barcode (one dimensional or two dimensional, i.e. a matrix barcode), or the entirety of the access right using a suitable scanning device. Upon the access right being scanned, the system 600 may be provided with an identification of the user and may access the user profile stored in the memory 612 and/or databases 616. In another embodiment a proof of purchase is stored in the user's profile. Upon accessing the venue, the user may then present their mobile device to venue staff, which may use any suitable acquisition device to capture and process a signal emitted by the user's mobile device. The emitted signal may contain the user's profile information, particularly the user's proof of purchase, and may serve to authenticate the user and validate that they are authorized to access the venue (i.e. that the user has acquired legitimate rights for admission to the event). Additional authentication techniques, such as facial recognition, Bluetooth, Radio-frequency identification (RFID) access, or the like, may also be used by the profile management module 504 to authenticate users accessing the venue.

Upon reaching their seat, the user may further scan seat indicia (e.g. a barcode) provided on the seat. Alternatively, staff at the venue may use a device they may be provided with to access the system 600 and enter the seat indicia information manually into the system 600 using suitable input means or interface elements (not shown), such as a keyboard or touchscreen. It should be understood that other techniques may be used to obtain an indication of the current seat occupied by a given user. The system 600 may then compare the scanned seat indicia with the seat allocation information associated with the user's profile to determine whether the user has reached the correct seat. If the system 600 identifies a discrepancy between the scanned seat indicia and the stored seat allocation data, a message to that effect may be generated and presented to the user, thereby providing an indication that the user is in the wrong seat. In this manner, it can be ensured that each user remains in the seat they have been uniquely allocated upon winning their bid.

While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment.

It should be noted that the present invention can be carried out as a method, can be embodied in a system, and/or on a computer readable medium. The embodiments of the invention described above are intended to be exemplary only. The scope of the invention is therefore intended to be limited solely by the scope of the appended claims.

1. A computer-implemented method for managing access rights to an event, the method comprising, at a computing device:
receiving, during a bidding procedure, real-time bidding data comprising one or more bids for acquiring access to the event based on user-specific criteria;
obtaining historical data, current data, and future data related to at least one of the event, a venue, and a content provider;
using at least one intelligent processing technique for outputting real-time insights based on the bidding data and on the historical data, the current data, and the future data, comprising at least one of:
returning, in real-time, a price to be paid to acquire at least one first access right meeting the user-specific criteria and to optionally bypass the bidding procedure; and
indicating, in real-time, at least one second access right that can be acquired immediately, in accordance with the one or more bids as received, to optionally bypass the bidding procedure;
receiving user input responsive to the insights; and
responsive to the user input, one of automatically allocating access rights to the event and granting access to an access rights selection platform.

2. The method of claim 1, wherein returning the price to be paid to acquire the at least one first access right meeting the user-specific criteria comprises using the at least one intelligent processing technique to determine, based on a point in time at which the one or more bids were placed and on at least one of the historical data, the current data, and the future data, a balance point in supply and demand for the at least one first access right, and determining the price based on the balance point and the bidding data.

3. The method of claim 1, wherein the historical data, the current data, and the future data vary in real-time, and further wherein generating the real-time insights based on the historical data, the current data, and the future data comprises using the at least one intelligent processing technique to adjust a weight allocated to each of the historical data, the current data, and the future data in real-time.

4. The method of claim 1, wherein the user-specific criteria comprises at least one of an event selection, at least one seat category, at least one seat section, and a number of seats to be purchased for the event.

5. The method of claim 1, wherein the historical data is obtained prior to a start of the bidding procedure and comprises at least one of demographic and socioeconomic factors related to the event and attendee market, demographic and socioeconomic factors related to a fan base of the content provider, historical performance metrics of the content provider, social media presence and performance of the content provider, data related to previous events from same or comparable content providers, previous data from same or comparable events, previous data from other events at the venue or similar venues, previous data from a specific location in the venue, and event data tagging.

6. The method of claim 1, wherein the current data is obtained during the bidding procedure and comprises any real-time change to the historical data, and further wherein the future data is obtained one or during the bidding procedure and after the bidding procedure ends and comprises any real-time change to the historical data and to the current data.

7. The method of claim 6, wherein the current data further comprises data related to the one or more bids actually placed during the bidding procedure and data related to one or more bids expected to be placed during the bidding procedure.

8. The method of claim 6, wherein obtaining the future data further comprises forecasting one or more pattern and statistical data points for the historical data and the current data.

9. The method of claim 1, wherein outputting the real-time insights comprises providing at least one of qualitative feedback and quantitative feedback on the one or more bids in real-time.

10. The method of claim 1, wherein receiving the user input responsive to the insights comprises receiving one of a modification to the one or more bids, an indication of acceptance to pay the price to acquire the at least one first access right meeting the user-specific criteria, an indication of acceptance to acquire the at least one second access right immediately, and an indication of acceptance to wait until an end of the bidding procedure to acquire access rights.

11. The method of claim 1, further comprising, prior to receiving the bidding data:
collecting the historical data, the current data, and the future data for at least one of each of a plurality of events, each of a plurality of venues, each of a plurality of content providers, and each of a plurality of users; and
using the at least one intelligent processing technique to calibrate and correlate the historical data, the current data, and the future data across at least one of the plurality of events, venues, and content providers for generating, for any given one of the plurality of users, real-time recommendations as to at least one of an event, a venue, a content provider, a seat category, a seat section, a bid amount deemed appropriate for the user.

12. A system for managing access rights to an event, the system comprising:
a processing unit; and
a non-transitory memory communicatively coupled to the processing unit and comprising computer-readable program instructions executable by the processing unit for:
receiving, during a bidding procedure, real-time bidding data comprising one or more bids for acquiring access to the event based on user-specific criteria;
obtaining historical data, current data, and future data related to at least one of the event, a venue, and a content provider;
using at least one intelligent processing technique for outputting real-time insights based on the bidding data and on the historical data, the current data, and the future data, comprising:
at least one of returning, in real-time, a price to be paid to acquire at least one first access right meeting the user-specific criteria and to optionally bypass the bidding procedure; and
indicating, in real-time, at least one second access right that can be acquired immediately, in accordance with the one or more bids as received, to optionally bypass the bidding procedure;
receiving user input responsive to the insights; and
responsive to the user input, one of automatically allocating access rights to the event and granting access to an access rights selection platform.

13. The system of claim 12, wherein the computer-readable program instructions are executable by the processing unit for returning the price to be paid to acquire the at least one first access right meeting the user-specific criteria, comprising:
using the at least one intelligent processing technique to determine, based on a point in time at which the one or more bids were placed and on at least one of the historical data, the current data, and the future data, a balance point in supply and demand for the at least one first access right; and
determining the price based on the balance point and the bidding data.

14. The system of claim 12, wherein the computer-readable program instructions are executable by the processing unit for generating the real-time insights based on the historical data, the current data, and the future data comprising using the at least one intelligent processing technique to adjust a weight allocated to each of the historical data, the current data, and the future data in real-time, the historical data, the current data, and the future data varying in real-time.

15. The system of claim 12, wherein the computer-readable program instructions are executable by the processing unit for obtaining the historical data prior to a start of the bidding procedure, obtaining the current data during the bidding procedure, and obtaining the future data during the bidding procedure and after the bidding procedure, the current data comprising any real-time change to the historical data, and the future data comprising any real-time change to the historical data and to the current data.

16. The system of claim 15, wherein the computer-readable program instructions are executable by the processing unit for obtaining the current data further comprising data related to the one or more bids actually placed during the bidding procedure and data related to one or more bids expected to be placed during the bidding procedure.

17. The system of claim 15, wherein the computer-readable program instructions are executable by the processing unit for obtaining the future data comprising forecasting one or more pattern and statistical data points for the historical data and the current data.

18. The system of claim 12, wherein the computer-readable program instructions are executable by the processing unit for outputting the real-time insights comprising providing at least one of qualitative feedback and quantitative feedback on the one or more bids in real-time.

19. The system of claim 12, wherein the computer-readable program instructions are executable by the processing unit for receiving the user input responsive to the insights comprising receiving one of a modification to the one or more bids, an indication of acceptance to pay the price to acquire the at least one first access right meeting the user-specific criteria, an indication of acceptance to acquire the at least one second access right immediately, and an indication of acceptance to wait until an end of the bidding procedure to acquire access rights.

20. The system of claim 12, wherein the computer-readable program instructions are further executable by the processing unit for, prior to receiving the bidding data:
collecting the historical data, the current data, and the future data for at least one of each of a plurality of events, each of a plurality of venues, each of a plurality of content providers, and each of a plurality of users; and
using the at least one intelligent processing technique to calibrate and correlate the historical data, the current data, and the future data across at least one of the plurality of events, venues, and content providers for generating, for any given one of the plurality of users, real-time recommendations as to at least one of an event, a venue, a content provider, a seat category, a seat section, a bid amount deemed appropriate for the user.
